(19) United States
(12) Patent Application Publication
(10) Pub. No.: US 2026/0071555 A1
(43) Pub. Date: Mar. 12, 2026

(54) DEVICE FOR GUIDING A SHAFT OF AN AIRCRAFT TURBINE ENGINE

(71) Applicant: SAFRAN AIRCRAFT ENGINES, Paris (FR)

(72) Inventor: Olivier FORMICA, Moissy-Cramayel (FR)

(21) Appl. No.: 19/108,708

(22) PCT Filed: Sep. 13, 2023
(86) PCT No.: PCT/FR2023/051392

§ 371 Date: Mar. 4, 2025

(30) Foreign Application Priority Data
Sep. 16, 2022 (FR) FR2209344

(51) Int. Cl. F01D 25/18; B64D 27/10; F01D 25/10; F01D 25/16

(52) U.S. Cl. CPC F01D 25/183; B64D 27/10; F01D 25/10; F01D 25/162; F05D 2240/50; F05D 2240/55; F05D 2260/96; F05D 2260/98

(57) ABSTRACT

A device for guiding a shaft of an aircraft turbine engine, the device including a rolling bearing;—an annular bearing support and—an oil film compression damping system including two annular sealing segments; and—a first oil supply circuit this first circuit being connected to an annular supply groove wherein the damping system further—includes a second oil supply circuit, this second circuit being connected to at least one annular temperature control groove which is independent of the supply groove and which runs around one of the sealing segments.

### TECHNICAL FIELD OF THE INVENTION

This invention relates to a device for guiding a shaft of an aircraft turbine engine and to an aircraft turbine engine comprising such a device.

### TECHNICAL BACKGROUND

The prior art includes in particular the documents FR-A1-2 876 758, FR-A1-3 085 242, FR-A1-3 088 680, US-A1-202/284298, FR-A1-3 093 531, FR-A1-2 664 330, US-A1-2017/248033 and US-A1-2016/369652.

Generally speaking, a turbine engine comprises rotating members such as shafts which are guided by guide bearings relative to a fixed structure of the turbine engine. Each of these guide bearings comprises an internal ring and an external ring enclosing rolling elements, for example rollers or balls. Typically, the external ring is securely mounted on a bearing support of the turbine engine and the internal ring is securely mounted on a rotating shaft of the turbine engine.

Some guide bearings may be associated with oil film compression damping systems, known as the squeeze film damper. An oil film is more or less trapped in an annular space which extends around the bearing so as to dampen the movements of the rotating shaft and reduce the vibrations of the latter which are transmitted to the bearing support and the fixed structure of the turbine engine and the aircraft. These damping systems also allow, through the damping of the rotor modes, a reduction in the consumption of rotor/stator play at each compressor and turbine stage, and consequently, an increase in engine performance. Finally, the damping systems allow the risk of the appearance of non-synchronous vibrations or NSV (acronym for Non Synchronous Vibrations) to be reduced, which can damage the engine, particularly when the shaft on which the damping system is placed is a supercritical rotor (with its first mode of flexion in the operating range of the engine). In general, the oil film allows for an improvement in the dynamic response of the turbine engine at a given operating speed and, consequently, in the performance of the turbine engine.

The annular space in which the oil film forms is delimited radially between the outer ring of the guide bearing (which is locked against rotation) and the bearing support, and axially by annular sealing segments. These segments allow the oil film to be kept under pressure (which provides the desired cushioning), while ensuring the evacuation of the oil.

Traditionally, the sealing segments are annular metal elements, elastically deformable, resistant to high temperatures and have a straight or cut slot or overlap in the tangential direction of the segment. This section allows the oil to be evacuated, with an oil flow rate specified by the overall dynamics. This flow rate must be sufficient to evacuate the heat generated by damping in the oil film, but not so high that the oil film remains under pressure.

As a guide, this flow rate can be in the order of a few dozen liters per hour, and the cross-section of each segment can be cut by a few tenths of a millimeter to a few millimeters. When they are assembled, these segments bear radially on the bearing support or a shrink ring mounted in this support, and axially on the walls of the channels that are formed in the external ring of the bearing (corresponding to the internal ring of the oil film) and which accommodate these segments. The oil can therefore only pass through the tangential clearance at the cut of each segment.

The clearance at the section of the segments varies in operation, due to the thermal gradient between the segment (which can be considered as a first approach to the oil temperature) and the bearing support or shrink ring on which it rests.

This thermal gradient changes during operation as a result of the temperature conditions of the oil and pieces during the various phases of the engine's life:
from start-up to take-off, the oil is hotter than the bearing support: the gradient between the oil (and therefore the segment, in direct contact with the oil), and the bearing support on which the segment rests, is negative. As the segment is hotter than the support (because it is in contact with the oil), it will want to expand axially, which will cause the clearance to close on cutting due to contact with the colder support;
from take-off to the end of the mission, the bearing support is hotter than the oil entering the film, so this gradient is positive. As the segment is colder than the support (because it is in contact with the oil), it will want to compress axially, which will lead to an opening of the cutting clearance due to contact with the warmer support.

During a typical flight mission, for example, there may be a thermal gradient of several tens of degrees between the oil and the temperature of the bearing support in line with the rolling bearing. During very transient phases (rapid acceleration or deceleration) outside the classic mission, this gradient may also vary significantly.

The objective of this invention is to provide an optimized damping device allowing the reduction of the thermal gradient between the sealing segments and the bearing support or the shrink ring with which they are in contact in the case of straight-cut sealing segments.

The document FR-A1-2 876 758 describes a sealing segment with an overlapping cut, which comprises notches for oil to pass through at its external periphery.

This solution reduces the static rotating force created by the single leak at the section, but does not reduce the thermal gradient p recited. Furthermore, the production of notches can be complex from an industrial point of view, costing two to three times more than conventional straight-cut segments. Finally, defining the geometry of these notches (height and width) requires complex calculations and validation tests to ensure that the leakage flow rate generated by these segments is in line with expectations.

### SUMMARY OF THE INVENTION

The invention relates to a device for guiding a shaft of an aircraft turbine engine, this device comprising:
a rolling bearing comprising two rings, a first ring and a second ring respectively, between which rolling elements are mounted,
an annular bearing support extending around the bearing, and
an oil film compression damping system mounted between the bearing support and the second ring, this damping system comprising:
an annular shrink ring interposed between the bearing support and the second ring,
two annular sealing segments, upstream and downstream respectively, which are housed in annular grooves formed in an external cylindrical surface of the second ring and which are able to bear radially on an internal cylindrical surface of the shrink ring, these external and internal surfaces defining between them an annular space for the formation of an oil film which is delimited axially by the sealing segments, each of these segments being slit by a straight cut to allow the evacuation of the oil from this space, and
a first oil supply circuit, this first circuit being connected to an annular supply channel which extends around the space and which is connected to this space by orifices formed in the shrink ring,
characterised in that the damping system further comprises:
a second oil supply circuit, this second circuit being connected to at least one annular heating channel which is independent of said supply channel and which extends around the space and in line with one of the sealing segments.

The invention therefore proposes equipping the guiding device with at least one heating channel, which is independent of the supply channel, and which is dedicated to reducing the aforementioned thermal gradient. It is therefore understood that the device comprises two oil circuits with different functions, as opposed to a single circuit in previous technology.

In the present application, a distinction is therefore made between the channels according to their function. The function of an oil supply channel is to supply oil, while the function of a heating channel is to regulate the temperature and therefore to supply or remove heat, with the aim of limiting the occurrence of a thermal gradient in particular.

The oil that circulates in the first circuit, and in particular in the annular supply channel, in the orifices and in the space, does not circulate in the second circuit, in particular in the heating channel, and vice versa.

The device according to the invention may comprise one or more of the following characteristics, taken alone or in combination with each other:
the supply channel is formed in the annular support or in the shrink ring;
said or each heating channel is formed in the annular support and/or in the shrink ring;
the supply channel has an axial extent greater than an axial extent of said orifices;
said or each heating channel has an axial extent greater than an axial extent of the sealing segment around which it extends;
the second oil supply circuit is connected to two heating channels, upstream and downstream respectively, which are located in line with said sealing segments;
said or each heating channel is connected to at least one oil outlet orifice which is formed in the shrink ring;
said at least one oil outlet orifice is axially offset from said space to prevent the oil exiting this orifice from entering the space;
the oil outlet orifice connected to the upstream heating channel opens upstream of the upstream sealing segment, or even upstream of the second ring;
the oil outlet orifice connected to the downstream heating channel opens downstream of the downstream sealing segment;

said or each heating channel is connected to at least one oil inlet orifice formed in the bearing support;
the oil inlet and outlet orifices of said or each heating channel are located at an angle to each other which is less than or equal to 30°, and preferably less than or equal to 20°; this angle is measured with respect to the axis of the bearing;
the oil inlet orifice of said or each heating channel is situated in an angular area extending between 12 o'clock and 1 o'clock about a main axis of the device by analogy with the dial of a clock according to a first configuration, or between 11 o'clock and 12 o'clock around the axis according to a second configuration, and the oil outlet orifice of said or each heating channel is located in an angular area extending between 11 o'clock and 12 o'clock around the axis according to the first configuration, or between 12 o'clock and 1 o'clock around the axis according to the second configuration;
the oil inlet and outlet orifices of said or each heating channel are inclined with respect to radial directions;
the first and second rings are respectively internal and external rings, or conversely external and internal rings;
the device comprises a main axis about which the bearing extends;
the cross-section of each segment extends in a plane parallel to said axis;
the second ring of the guiding device is associated with a flexible cage and comprises an openwork annular web connected to an annular fixing flange;
the oil pressure in the first supply circuit is higher than the oil pressure in the second supply circuit;
the oil pressure in the heating channel(s) is between 1.5 and 10 bar;
each of the segments defines a cutting clearance of between 0.05 and 5 mm in the position in which it is mounted in the device;
said or each heating channel has an axial extent which is one to five times an axial extent of the segment associated with this channel;
the oil film or the space where this oil film is formed has a radial thickness of between 0.05 and 1 mm;
the axial distance between the segments or the length of the oil film or of the space where the oil film is formed is between 10 and 50 mm;
the oil film or the space where the oil film is formed has a diameter of between 100 and 500 mm;
said or each supply channel is of the centered type and is located midway between the sealing segments;
said or each supply channel is of the decentered type and is located close to one of the sealing segments;
when the supply channel is of the centered type, the device comprises exactly two heating channels;
when the supply channel is of the decentered type, the device comprises a single heating channel.

The invention also relates to an aircraft turbine engine, comprising a device as described above.

### BRIEF DESCRIPTION OF THE FIGURES

Further characteristics and advantages will be apparent from the following description of a non-limiting embodiment of the invention with reference to the appended drawings wherein:

FIG. 1 is a schematic half-view in axial section of an aircraft turbine engine;

FIG. 2 is a schematic axial cross-section and perspective view of a guiding device in the prior art,

FIG. 3 is a schematic cross-sectional view of the guiding device shown in FIG. 2,

FIG. 4 is a schematic axial sectional view of the guiding device shown in FIG. 2,

FIG. 5 is a schematic perspective view of a cross-sectional sealing segment,

FIG. 6 is a schematic perspective view of a sealing segment with an overlapping cut,

FIG. 7 is a schematic axial cross-section similar to that of FIG. 4 and illustrates an embodiment of a guiding device according to the invention,

FIG. 8 is a similar view to FIG. 7 and illustrates an alternative embodiment of the invention,

FIG. 9 is a similar view to FIG. 7 and illustrates another embodiment of the invention, and

FIG. 10 is a very schematic view of a heating channel of a guiding device according to the invention, and shows the positions of the oil inlet and outlet orifices of this channel.

### DETAILED DESCRIPTION OF THE INVENTION

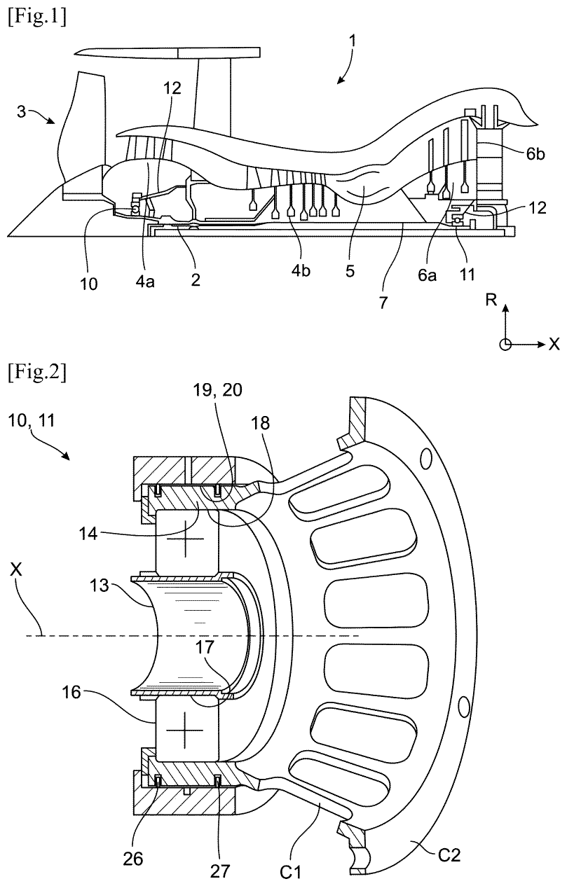

FIG. 1 is a partial axial sectional view of a turbine engine 1 of longitudinal axis X to which the invention applies. The turbine engine 1 shown is a dual flow turbine engine designed to be mounted on an aircraft.

Typically, the turbine engine 1 comprises a rotating shaft which is guided in rotation via one or more guide bearings relative to a fixed part of the turbine engine. The rotating shaft may be a low-pressure shaft on the turbine engine. The rotating shaft can also be a high-pressure shaft or any shaft driven in rotation by means of a guide bearing within the turbine engine.

With reference to FIG. 1, the low-pressure shaft 2 drives, for example, a fan 3 located upstream of the turbine engine 1. The turbine engine 1 comprises, downstream of the fan 3 and in succession, a compressor assembly (low-pressure compressor 4a and high-pressure compressor 4b), a combustion chamber 5, and a turbine assembly (high-pressure turbine 6a and low-pressure turbine 6b), which form a gas generator.

In the present invention, the terms “upstream” and “downstream” are defined in relation to the flow of gases in the turbine engine and here along the longitudinal axis X.

The low-pressure shaft 2 connects the low-pressure compressor 4a of the compressor assembly and the low-pressure turbine 6b of the turbine assembly to form a low-pressure casing. The turbine engine 1 may also comprise a high-pressure body which comprises the high-pressure compressor 4b of the compressor assembly connecting the high-pressure turbine 6a of the turbine assembly via a high-pressure shaft 7.

The low-pressure shaft 2 is centred on the longitudinal axis X and is guided at its upstream end by an upstream guide bearing 10 and at its downstream end by a downstream guide bearing 11. The guide bearings 10, 11 are each housed in an enclosure of a fixed casing 12 relative to which the low-pressure shaft 2 rotates.

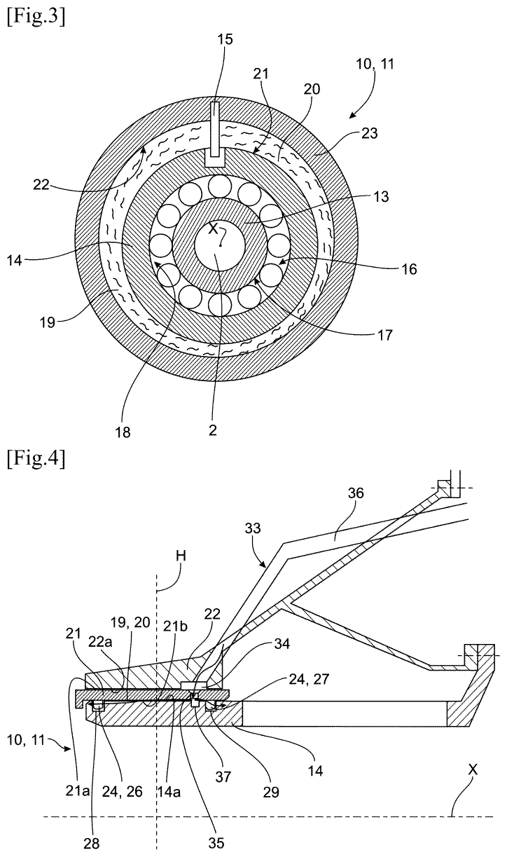

With reference to FIGS. 2 to 4, each bearing 10, 11 comprises an annular internal ring 13 mounted on the rotating shaft (low-pressure shaft 2) and an annular external ring 14 connected to a fixed structure secured to the fixed casing 12 of the turbine engine 1. For example, the internal ring 13 is shrunk onto the low-pressure shaft 2 in such a way as to prevent any translation or rotation of the internal ring 13 relative to the low-pressure shaft 2. Advantageously, the external ring 14 is fixed to the fixed structure by means of an anti-rotation device to prevent it from rotating relative to the fixed structure. The anti-rotation device is generally formed by a radial spacer 15 which is housed, on the one hand, in a notch in the external ring 14 which opens outwards and, on the other hand, in a hole (not shown) in the fixed structure secured to the fixed casing 12. The external ring 14 surrounds and is spaced radially from the internal ring 13.

In the present invention, the terms “radial” and “radially” are defined with respect to a radial axis R perpendicular to the longitudinal axis X.

Between the internal and external rings 13, 14, rolling elements 16 such as rollers or balls are arranged, which provide the link between the rotating shaft and the fixed structure of the turbine engine. The internal and external rings 13, 14 comprise internal surfaces 17, 18 which form internal rolling tracks for the rolling elements 16.

FIGS. 2 to 4 also show that the bearing 10, 11 is fitted with a damping system. The latter comprises a damping film which is an oil film 19 and which circulates between the external ring 14 and the fixed structure of the turbine engine. This oil film 19 limits, dampens or regulates the vibrations of the turbine engine 1 during operation. The turbine engine 1 is known to vibrate in at least one given vibration mode when one or more rotating shafts rotate. These vibrations are due, for example, to imbalances in the turbine engine 1 and unbalances generated as a result of these imbalances.

The oil film 19 is designed to occupy an annular damping space 20. In the case of FIG. 4, the space 20 is located radially between the external ring 14 of the guide bearing and an annular shrink ring 21 (i.e. a shrunk-on annular piece) mounted in an annular bearing support 22 which forms part of or is fixed to the fixed structure. In other words, the shrink ring 21 surrounds the external ring 14 of the bearing 10, 11 and is itself surrounded by the bearing support 22.

The bearing support 22 comprises an internal cylindrical surface 22a which faces an external cylindrical surface 21a of the shrink ring 21. The shrink ring 21 comprises an internal cylindrical surface 21b which faces an external cylindrical surface 14a of external ring 14 of the bearing 10, 11. The surfaces 22a and 21a are in contact with each other. The surfaces 21b and 14a are radially spaced from each other and the radial clearance between these surfaces 21b and 14a is predetermined to define the radial dimension of the space 20 for forming the oil film 19.

The damping space 20 is also delimited axially by sealing segments 24 which regulate or allow oil “leakage” from the damping film to the outside of the space 20. These segments control the leakage flow rate of the damping film to ensure effective vibration damping. In the present invention, the terms “axial” and “axially” are defined with respect to the longitudinal axis X.

A first annular segment 26 is located upstream of the space 20 and a second annular segment 27 is located downstream of the space 20. The segments 26, 27 extend radially between the external ring 14 and the shrink ring 21. The external ring 14 comprises a first annular groove 28, upstream, and a second annular channel 29, downstream, designed to receive the segments 26, 27 respectively. The grooves 28, 29 are formed in the surface 14a of the external ring 14 and are spaced axially apart. The segments 26, 27 extend radially from their grooves 28, 29 and are able to rest radially on the surface 21b of the shrink ring. They are also designed to bear on the side walls of the channels (the upstream segment 26 on the upstream wall of the upstream groove 28, and the downstream segment 27 on the downstream wall of the downstream groove 29) as a result of the pressure exerted by the film oil during operation.

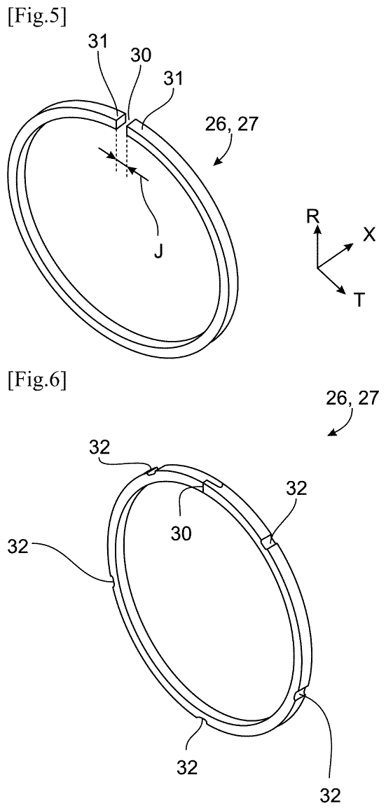

The segments 26, 27 are slotted and each comprise a cut or slot 30 which forms facing ends 31 (see FIG. 5). This is called a straight cut. Each end 31 is defined in a plane which is parallel to an plane RX. The plane RX is formed by the longitudinal axis X and the radial axis R. The segments 26, 27 have a generally square or rectangular cross-section.

In the current technique shown in FIG. 6, the segments 26, 27 can also be split and each comprise an overlapping cut 30. In this case, each end comprises a tongue extending in a circumferential direction (transverse axis T). The transverse axis T is perpendicular to the longitudinal axis X and the radial axis R. The two tongues each have a surface intended to rest axially against each other and an axially opposite surface which is flush with one side of the segment. The segments 26, 27 can also be provided with notches 32 on their outer periphery. These notches are evenly distributed around the axis of the segment (parallel to the longitudinal axis X in the installation situation) and enable the power dissipated by damping in the oil film 19 to be evacuated.

In the present invention, the segments 26, 27 are of the straight-cut type as shown in FIG. 4. The cut clearance J, i.e. the distance between the circumferential ends of a segment, when mounted in the device, is preferably between 0.5 and 5 mm.

The turbine engine 1 is also equipped with a first supply circuit 33 which is connected to a supply source (not shown) so as to supply pressurised oil to the space 20 and to form the oil film 19 in this space. This first circuit 33 can also supply oil to the guide bearings to lubricate them.

To this end, as illustrated in FIG. 4, the bearing support 22 comprises an annular supply channel 34 which extends around the space 19 and is connected to this space by orifices 35 formed in the shrink ring 21. The channel 34 is connected to a pipe 36 which is schematically shown here. The channel 34 extends around the space 19, between the segments 26, 27, and at a predetermined axial position relative to these segments 26, 27. The channel 34, orifices 35 and pipe 36 form part of the supply circuit 33.

The orifices 35 are calibrated and their number is between 1 and 12. They are preferably evenly distributed around the axis X.

In the example shown in FIG. 4, the channel 34 is of the off-centre type or the oil film feed 19 is of the off-centre type. H is defined as a median plane perpendicular to X and passing roughly through the middle of the oil film. It can be seen that the channel 34 is not traversed by this plane H and is instead at a distance from this plane H and here downstream of this plane, close to the downstream segment 27.

Alternatively, the supply channel could be of the centred type or the feed to the oil film 19 could be of the centred type. To achieve this, the channel would be traversed by plane H and would therefore be approximately halfway between segments 26 and 27.

FIG. 4 also shows the flow of oil in the circuit 33, from the pipe 36 to the channel 34 (arrow F1), through the orifices 35 in the shrink ring 21, then from the space 20 through the cross-sections of the segments 26, 27. In line with the orifices 35, the external surface 14a of the ring 14 may comprise an annular groove 37 for collecting the oil leaving the orifices 35 and distributing this oil in the space 20 all around the axis X.

The thermal gradient between the segments 26, 27 and the shrink ring 21 on which they rest radially is not measured in operation and is therefore not well known. It can be between 5 and 100° C., for example. This gradient is nevertheless used as a hypothesis to define the tangential clearance, known as the “cut clearance” of the segments 26 and 27.

In the presence of a negative gradient (the temperature of the segment is similar to the temperature of the oil and higher than the temperature of the shrink ring), the segment will want to lengthen by thermal expansion, and its gap will therefore close as a result of the imposed gradient.

There are three distinct cases. In the first case, we see a functioning that does not call into question the functioning of the film, the segment closes at the cut-off, but the closing clearance imposed by this gradient is less than the cut-off, and the evacuation of the oil can therefore take place normally. This case does not call into question the operation of the film.

In a second case, where the clearance at the cut (tangential clearance) is poorly defined or the thermal gradient used to define this clearance is underestimated, the segment will want to close beyond the value of the predicted clearance. As a result, the oil in the oil film 19 can no longer be evacuated, and will therefore rise very sharply in temperature (due to the heat generated by damping the oil film), which will reduce its viscosity, and therefore the damping power of the film. If the gradient is too high and the segment is closed for too long, there may also be a risk of oil coking, making the film completely non-functional and requiring it to be dismantled for cleaning.

In the third case, where the negative thermal gradient is even greater in absolute value than in the second case, the segment will want to close even more. Because of the radial clearance between the segment 26, 27 and the groove 28, 29 which accommodates the segment, the two ends of the segment will want to press against each other radially at the bottom of the channel. As a result, the oil will be evacuated via the space left between the outer diameter of the segment and the shrink ring, which can lead to very large leaks, larger than in normal operation. If these leaks are too large, it will not be possible to achieve sufficient supply pressure in the oil film, which will reduce the damping provided by the film.

On the other hand, in the second and third cases, once the gradient has returned to positive, the segment will want to regain its position with an open clearance. These two cases, with these compression/decompression cycles of the segment, repeated on each aircraft mission (or for transient variations outside the aircraft's classic mission), can therefore generate a risk of plasticization of the segment, which would therefore retain its deformed shape instead of its initial shape, and would therefore no longer be functional.

The consequences in the second and third cases are to have a film that is non-functional or with degraded (or even very degraded) operation compared with its nominal operation, with a reduction or even loss of the damping provided by this film.

The consequences are as follows:
increased vibrations,
deterioration in the relative clearances between the rotor and stator in the various compressor and turbine stages, and deterioration in performance, or even an increase in the risk of surge,
the appearance of non-synchronous vibrations (NSV), which can damage the engine, particularly if the film is placed on a supercritical rotor.

There is therefore a need to reduce or at least control this thermal gradient, which is what the invention proposes.

The present invention thus proposes the addition of a second oil supply circuit, which is dedicated to the heating of the segments 26 and 27. To do this, the second circuit is connected to at least one annular heating channel which extends around the space 20 and in line with one of the segments 26, 27.

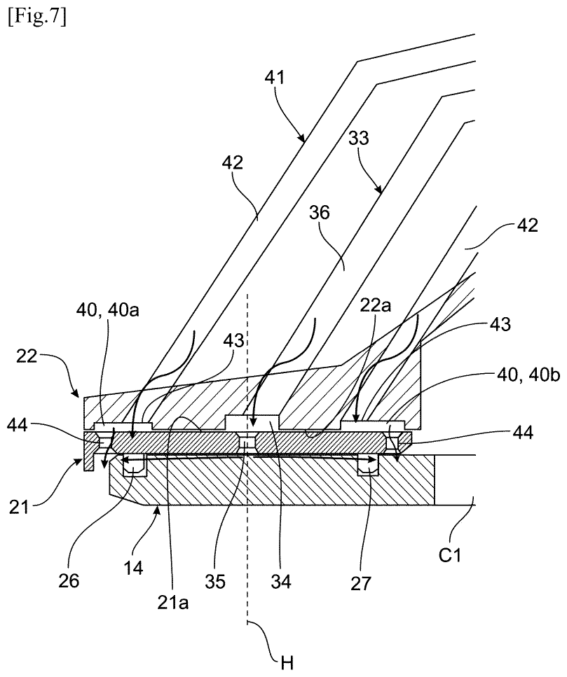

FIGS. 7 to 9 illustrate several embodiments in which the guidance device can be used in accordance with the invention. The differences between these embodiments are based in particular on the number and position of the heating channels 40, and on the position of the supply channel 34.

Although not necessarily apparent from or described in the following, the guiding device according to the invention may include some or all of the characteristics of a guiding device of the prior art, such as that illustrated in FIGS. 2 to 5 and described in the foregoing. In particular, its external ring 14 could be associated with a flexible cage C1 or squirrel cage, i.e. a perforated cage connected to an annular fixing flange C2, as shown in FIG. 2.

FIG. 7 illustrates a first embodiment of a guiding device according to the invention, wherein the heating channels 40 are formed in the bearing support 22 and in particular in the internal surface 22a of the support 22. This is also the case for the supply channel 34 which is formed in the support 22 and in particular in the internal surface 22a of the support 22.

In this case, the channel 34 is of the centered type and is therefore crossed by the plane H. There are two channels 40, respectively an upstream channel located upstream of plane H and a downstream channel located downstream of the plane H.

The channel 34 is rectangular or square in cross-section, for example.

In the example shown, the channel 34 has an axial extent greater than an axial extent of the orifices 35.

The upstream channel 40 extends around the space 20 and around and in line with the upstream segment 26. The downstream channel 40 extends around the space 20 and around and in line with the downstream segment 27.

Each channel 40 is rectangular or square in cross-section, for example. The shape and dimensions of the channels 40 are identical and each defines a volume which may be less than the volume defined by the channel 34.

In the example shown, each channel 40 has an axial extent greater than an axial extent of the segment 26, 27 around which it extends. Each channel 40 preferably has an axial extent of one to five times the axial extent of the corresponding segment, and preferably two to five times.

The channels 40 form part of a circuit 41 which comprises one or more pipes 42 supplying oil to the channels 40. Each of the channels 40 is supplied with oil by a pipe 42 in the example shown, the pipes being independent of the pipe 36.

The number of pipes 42 feeding a channel 40 is, for example, between 1 and 3. The supply pipes 42 in a single channel 40 are preferably evenly distributed around the axis X.

Each pipe 42 has an end which opens into the corresponding channel 40 to form an oil inlet orifice 43. The shrink ring 21 comprises at least one radial orifice, and preferably a single radial orifice, which forms an oil outlet orifice 44.

With regard to the upstream channel 40a, the oil outlet orifice 44 communicates with the upstream end of the channel 40 and is located upstream of the segment 26, or even upstream of the ring 14. The arrows show the oil's path through this area.

As regards the downstream channel 40b, the oil outlet orifice 44 communicates with the downstream end of the channel 40b and is located downstream of the segment 27. The arrows show the oil's path through this area.

The circuits 33, 41 are preferably independent. This means that the oil which circulates in the first supply circuit 33, and in particular in the annular supply channel 34, in the orifices 35 and in the space 20, does not circulate in the second supply circuit 41, in particular in the heating channel 40 and the oil outlet orifice 44, and vice versa.

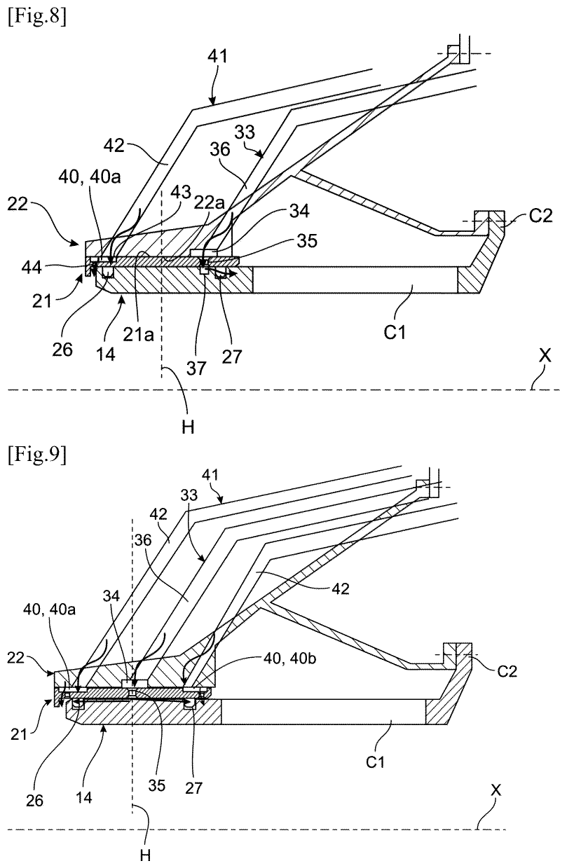

In the variant shown in FIG. 8, the channel 34 is decentered and distant from the plane H. It is located downstream of the plane H and close to the segment 27. It can be seen as extending partly around and in line with the segment 27. In this case, there is no heating channel 40 in this area. In fact, closing this segment, due to the appearance of a temperature gradient with the shrink ring, would be less problematic, as it would encourage the circulation of oil towards the opposite segment, which would increase damping.

The guiding device shown in FIG. 8 thus comprises a single channel 40, 40a located upstream of the plane H and around the segment 26. In the example shown, this channel 40 is formed in the shrink ring 21 and in particular in the external surface 21 of the shrink ring 21. The supply pipe 42 for this channel 40 is similar to that supply pipe for the channel 40a in FIG. 7.

The circuit 33 is similar to that shown in FIG. 4. The channel 34, the orifices 35 and the pipe 36 of the circuit 33 in FIG. 8 are similar to the upstream channel 40a, the orifices 35 and the pipe 36 connected to this channel in FIG. 4.

The embodiment shown in FIG. 9 differs from the embodiment shown in FIG. 7 in that the channels 40 are formed in the shrink ring 21 and not the support 22, and in particular in the external surface 21a of the shrink ring 21.

The circuits 36, 41 are preferably independent and can supply oil, for example from the same oil source, at different pressures. The oil supply pressure of the second circuit 41 is preferably lower than that of the first circuit 36. To achieve this, the circuit 41 can be connected to the oil source by a pump supplying a lower pressure than that supplied by another pump connecting the circuit 36 to the oil source. Alternatively, the circuits 36, 41 could be connected to the oil source by the same pump and the circuit 41 could be configured to reduce the pressure of the oil supplied by the pump, for example by controlled pressure drops in the pipe 42.

The oil pressure in the circuit 41 or said or each channel 40 is preferably between 1.5 and 10 bar. The oil pressure in the circuit 36 or the channel 34 is preferably greater than 10 bar.

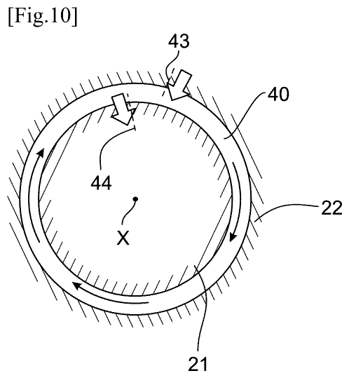

FIG. 10 shows, very schematically, one of the heating channels 40 and the respective positions of its oil inlet and outlet orifices 43, 44.

The oil inlet and outlet orifices 43, 44 of said or each heating channel 40 are located at an angle to each other which is less than or equal to 30°, and preferably less than or equal to 20° (measured around the axis X).

In the example shown, the oil inlet orifice 43 is formed by the opening of the pipe 42 into the channel 40 and is located, for example, close to the 12 o'clock position by analogy with the face of a clock (around the axis X). In the example shown, the oil inlet orifice 43 is located in an angular area extending between 12 o'clock and 1 o'clock around the axis X. The oil outlet orifice 44 is formed by the aforementioned orifice and is located at 11 o'clock and 12 o'clock around the axis X.

Alternatively, the oil outlet orifice 44 could be located in the angular area extending between 12 o'clock and 1 o'clock, and the oil inlet orifice 43 could be located in the angular area extending between 11 o'clock and 12 o'clock around the axis X.

As another possible variant, depending on integration constraints, the orifices can be located at different azimuths, while maintaining the “clocking” (relative azimuthal position) between the oil inlet and outlet orifices (+/−1 h), with, for example, inclined orifices (instead of purely radial ones) to force the direction of circulation of the oil flux between the oil inlet orifice and the oil outlet orifice, coupled with the supply pressure imposed on this oil flux.

The segments 26, 27, for example, are made of a metal alloy. An example of a metal alloy is a mixture of copper or iron.

The oil film 19 preferably has a radial thickness of between 0.05 and 1 mm. The segments 26, 27 are separated from each other by a distance of between 10 and 50 mm, which corresponds to the length of the oil film.

The oil film 19 can be located at an implantation radius (measured with respect to the axis X) of between 100 and 500 mm.

In operation, at the start of the mission, the oil is therefore intended to arrive both in the space 20 for the formation of the oil film 19 and in the heating channel(s) 40. This oil will therefore increase the temperature of the shrink ring 21 more quickly, and therefore mathematically reduce the gradient between the segment(s) 26, 27 and the shrink ring 21.

The oil arriving in this channel 40 is then discharged via the outlet orifice 44, to ensure that the oil runs around the entire circumference of the channel 40 (arrows in FIG. 10).

The aforementioned dimensions of the channel(s) 40, their shape (rectangular or not), and the inlet and outlet orifices 43, 44 can be defined using standard thermal calculations.

The invention therefore offers a simple and passive way of reducing the thermal gradient between the segments 26, 27 and the shrink ring 21 or the bearing support 22 on which the segments rest radially, which will therefore reduce the risk of the segment “over-closing” in the event of tangential clearance at the cut or a thermal gradient that is underestimated at the design stage.

This ensures better control of the damping of the film whatever the operating phase of the engine, and this reduced gradient variation minimises the evolution of this clearance on the cut, which guarantees less variation in the leakage flow rate and therefore better control/robustness of the damping of the oil film.

In contrast to the above, the bearing support 22 and the shaft 13 could have a reverse arrangement, with the bearing support 22 being located inside the bearing 10, 11 and the shaft 13 being located outside the bearing 10, 11.

1. A device for guiding a shaft of an aircraft turbine engine, the device comprising:
a rolling bearing, comprising two rings, a first ring and a second ring respectively, between which rolling elements are mounted,
an annular bearing support extending around the bearing, and
an oil film compression damping system mounted between the bearing support and the second ring, this damping system comprising:
an annular shrink ring interposed between the bearing support and the second ring,
two annular sealing segments upstream and downstream respectively, which are housed in annular grooves formed in an external cylindrical surface of the second ring and which are able to bear radially on an internal cylindrical surface of the shrink ring these external and internal surfaces defining between them an annular space for the formation of an oil film which is delimited axially by the sealing segments, each of these segments being slit by a straight cut to allow the evacuation of the oil from this space, and
a first oil supply circuit this first circuit being connected to an annular supply channel which extends around the space and is connected to this space by orifices formed in the shrink ring,
characterised in that the damping system further comprises:
a second oil supply circuit this second circuit being connected to at least one annular heating channel which is independent of said supply channel and which extends around the space and in line with one of the sealing segments.

2. The device according to claim 1, wherein the supply channel is formed in the annular support or in the shrink ring.

3. The device according to claim 1, wherein said or each heating channel is formed in the annular support and/or in the shrink ring.

4. The device according to claim 1, wherein the supply channel has an axial extent greater than an axial extent of said orifices.

5. The device according to claim 1, wherein said or each heating channel has an axial extent greater than an axial extent of the sealing segment around which it extends.

6. The device according to claim 1, wherein the second oil supply circuit is connected to two heating channels upstream and downstream respectively, which are located in line with said sealing segments.

7. The device according to claim 1, wherein said or each heating channel is connected to at least one oil outlet orifice which is formed in the shrink ring.

8. The device according to claim 7, wherein said at least one oil outlet orifice is axially offset from said space to prevent the oil exiting said orifice from entering the space.

9. The device according to 6, wherein the oil outlet orifice connected to the upstream heating channel opens up upstream of the upstream sealing segment, or upstream of the second ring and said or each heating channel is connected to at least one oil outlet orifice which is formed in the shrink ring.

10. The device according to claim 6, wherein the oil outlet orifice connected to the downstream heating channel opens up downstream of the downstream sealing segment and wherein said or each heating channel is connected to at least one oil outlet orifice which is formed in the shrink ring.

11. The device according to 7, wherein said or each heating channel is connected to at least one oil inlet orifice which is formed in the bearing support

12. The device according to claim 11, wherein the oil inlet and outlet orifices of said or each heating channel are located at an angle to each other which is less than or equal to 30°, and preferably less than or equal to 20°.

13. The device according to claim 11, wherein the oil inlet orifice of said or each heating channel is situated in an angular area extending between 12 o'clock and 1 o'clock about a main axis of the device by analogy with the dial of a clock according to a first configuration, or between 11 o'clock and 12 o'clock around the axis according to a second configuration, and the oil outlet orifice of said or each heating channel is located in an angular area extending between 11 o'clock and 12 o'clock around the axis according to the first configuration, or between 12 o'clock and 1 o'clock around the axis according to the second configuration.

14. The device according to claim 1, wherein the oil inlet and outlet orifices of said or each heating channel are inclined with respect to the radial directions.

15. The device according to claim 1, wherein the second ring of the guiding device is associated with a flexible cage and comprises an openwork annular web connected to an annular fixing flange.

16. The device according to claim 1, wherein said or each heating channel has an axial extent which represents one to five times an axial extent of the segment associated with this channel.

17. The device according to claim 1, wherein when each supply channel is of the centered type, the device comprises exactly two heating channels.

18. The device according to claim 1, wherein when the supply channel is of the decentered type, the device comprises a single heating channel.

19. An aircraft turbine engine comprising a shaft guided in rotation by a device according to claim 1.

20. The device according to claim 6 wherein said or each heating channel is connected to at least one oil outlet orifice which is formed in the shrink ring and wherein said at least one oil outlet orifice is axially offset from said space to prevent the oil exiting said orifice from entering the space.
